(19) United States
(12) Patent Application Publication
(10) Pub. No.: US 2026/0320404 A1
(43) Pub. Date: Oct. 15, 2026

(54) DISTRIBUTIONAL REINFORCEMENT LEARNING METHOD FOR MILITARY DECISION MAKING IN OFFLINE ENVIRONMENT AND COMPUTING DEVICE FOR PERFORMING SAME

(71) Applicant: FOUNDATION OF SOONGSIL UNIVERSITY-INDUSTRY COOPERATION, Seoul (KR)

(72) Inventors: MINHAE KWON, Seoul (KR); JAEHWI LEE, Seoul (KR); CHANIN EOM, Seoul (KR)

(21) Appl. No.: 19/297,244

(22) Filed: Aug. 12, 2025

(30) Foreign Application Priority Data
Mar. 28, 2025 (KR) 10-2025-0040270
May 20, 2025 (KR) 10-2025-0065571

(51) Int. Cl. G06N 3/092; G06Q 50/26

(52) U.S. Cl. CPC G06N 3/092; G06Q 50/26

(57) ABSTRACT

A distributional reinforcement learning method for military decision making in an offline environment includes acquiring enemy-related information and friendly-related information at each time step, generating a data set including a state, an action, and a reward based on the enemy-related information and friendly-related information of each time step, and training a neural network including a value network, a critic network, and an actor network based on the data set.

### CROSS-REFERENCE TO RELATED APPLICATIONS AND CLAIM OF PRIORITY

This application claims the benefit under 35 USC § 119 of Korean Patent Application Nos. 10-2025-0040270, filed on Mar. 28, 2025, and 10-2025-0065571, filed on May 20, 2025, in the Korean Intellectual Property Office, the entire disclosure of which is incorporated herein by reference for all purposes.

### BACKGROUND

### 1. Technical Field

Embodiments of the present disclosure relate to a distributional reinforcement learning technique for military decision making in an offline environment.

### 2. Description of Related Art

In existing decision making systems, methods based on reinforcement learning (RL) are actively being studied. In particular, traditional reinforcement learning algorithms that use scalar-type return values have been utilized to optimize policies in various environments. However, such methods have a structural limitation in that they do not sufficiently reflect the uncertainty of the environment. Since the methods do not take into account the variance or risk in the return values, they are inadequate for a long-term strategy establishment in a complex or dynamic environment.

In addition, online reinforcement learning has the limitation in that it may cause cost or safety issues because it requires real-time interaction, whereas offline reinforcement learning has the advantage of being able to learn without additional interaction with the environment by utilizing data collected in advance. Therefore, a method is required that can perform efficient decision making through offline reinforcement learning while addressing the problems of scalar-based reinforcement learning.

Meanwhile, as the complexity of military operations has increased recently, artificial intelligence-based commander decision making support technology is becoming important. In this situation, the weapon-target assignment (WTA) problem is closely linked to various defense technologies such as command decision AI system, intelligent battlefield awareness and judgment, and autonomous tactical decision making, and plays a key role in establishing a digital defense system.

The weapon-target assignment (WTA) problem aims to effectively allocate friendly weapon resources while inflicting effective damage on the enemy. In order to achieve the strategic goal of the commander, resource optimization at the target level desired by the commander should be made, not simply maximizing damage, and thus the importance of the weapon-target assignment problem is being emphasized in modern military operations.

Accordingly, methods based on reinforcement learning have begun to be introduced to the weapon-target assignment problem, but online reinforcement learning has limitations in requiring real-time interaction, and thus an offline reinforcement learning method is required for optimal decision making in a military environment.

Examples of related art include Korean Unexamined Patent Application Publication No. 10-2025-0031477 (2025 Mar. 7) and Korean Registered Patent Publication No. 10-2480564 (2022 Dec. 22).

### SUMMARY

Embodiments of the present disclosure are intended to provide a distributional reinforcement learning technique that can make military efficient decisions through offline reinforcement learning while addressing the problems of scalar-based reinforcement learning.

A learning method according to an embodiment of the present disclosure is a method performed on a computing device that includes one or more processors and a memory storing one or more programs executed by the one or more processors, the learning method including acquiring enemy-related information and friendly-related information at each time step in each episode, generating a data set including a state, an action, and a reward based on the enemy-related information and friendly-related information of each time step, and training a neural network including a value network, a critic network, and an actor network based on the data set, in which the training of the neural network includes inputting a state to the value network and outputting a first prediction value, which is a scalar value, converting the first prediction value into a first prediction probability distribution for each interval based on the first prediction value, calculating a first target value, which corresponds to the first prediction value and is a scalar value, converting the first target value into a first target probability distribution for each interval based on the first target value, and updating parameters of the value network based on the first prediction probability distribution and the first target probability distribution.

The converting into the first prediction probability distribution may include inputting the first prediction value output from the value network into a first additional layer connected to an output terminal of the value network to output first logit values of a plurality of intervals, and calculating the first prediction probability distribution of each interval by applying a softmax function to each of the first logit values.

The generating of the data set may include calculating an n-step cumulative reward for each time step based on the reward for each time step, and in the calculating of the first target value, the first target value may be calculated based on an n-step cumulative reward for the current time step and the first prediction value of the value network for an n-th time step based on the current time step.

The converting into the first target probability distribution may include generating a first normal distribution, which is a normal distribution having the first target value as an average, dividing an interval between a minimum value and a maximum value of the first normal distribution into a plurality of intervals and calculating a first target probability distribution for each interval by integrating the first normal distribution for each interval of the first normal distribution.

The training of the neural network may further include inputting a state and an action to the critic network and outputting a second prediction value, which is a scalar value, converting the second prediction value into a second prediction probability distribution for each interval based on the second prediction value, calculating a second target value, which is a scalar value and corresponds to the second prediction value, converting the second target value into a second target probability distribution for each interval based on the second target value, and updating parameters of the critic network based on the second prediction probability distribution and the second target probability distribution.

The converting into the second prediction probability distribution may include inputting the second prediction value output from the critic network into a second additional layer connected to an output terminal of the critic network to output second logit values of a plurality of intervals and calculating the second prediction probability distribution of each interval by applying a softmax function to each of the second logit values.

In the calculating of the second target value, the second target value may be calculated based on a reward for the current time step and the first prediction value of the value network for the next time step.

The converting into the second target probability distribution may include generating a second normal distribution which is a normal distribution having the second target value as an average, dividing an interval between a minimum value and a maximum value of the second normal distribution into a plurality of intervals, and calculating a second target probability distribution for each interval by integrating the second normal distribution for each interval of the second normal distribution.

The learning method may further include inputting a state into the actor network and outputting a predicted action, calculating an advantage function based on a difference between a mode value of the first prediction probability distribution for each interval and a mode value of the second prediction probability distribution for each interval, and updating parameters of the actor network based on a difference between the predicted action and the action in the data set and the advantage function.

Information on the state may include one or more of a defense level according to a state of an enemy unit, a distance between the enemy unit and a friendly unit, a health of the enemy unit, a desired effect of a commander for the corresponding episode, an ammunition supply rate of each weapon of the friendly unit, and an available ammunition quantity for each weapon of the friendly unit, and information on the action may include one or more of a type of friendly unit performing the action, an ammunition type selected by the friendly unit, and an ammunition usage amount selected by the friendly unit.

In the generating of the data set, a reward for the current time step may be set based on information on the state and action of the current time step and information on the state of the next time step, and the reward may be set based on one or more preset reward functions, the reward functions may include a first reward function, and the first reward function may be prepared to receive a reward or a penalty based on a comparison between the health of the enemy unit and the desired health of the enemy unit.

The first reward function may be prepared so that, when the health of the enemy unit of the next time step exceeds the desired health of the enemy unit, a reward is given in proportion to a difference between the health of the enemy unit and the desired health of the enemy unit, and may be prepared so that, if the desired health of the enemy unit exceeds the health of the enemy unit of the next time step, but the difference between the health of the enemy unit and the desired health of the enemy unit exceeds a preset allowable margin, a penalty is given as much as the allowable margin is exceeded.

The generating of the data set may include calculating the health of the enemy unit of the next time step based on the health of the enemy unit of the current time step, the ammunition usage amount of an ammunition type selected by the friendly unit of the current time step, and a health reduction ratio of the enemy unit caused by the friendly unit.

The reward functions may further include a second reward function, and the second reward function may be prepared so that a penalty is given in proportional to the ammunition usage amount of the friendly unit of the current time step.

The reward functions may further include a third reward function, and the third reward function may be prepared so that when the final health of the enemy unit at the end of the episode falls below the desired health of the enemy unit, a penalty is given thereto.

A computing device according to an embodiment of the present disclosure includes one or more processors, a memory, and one or more programs, in which the one or more programs are stored in the memory and configured to be executed by the one or more processors, and the one or more programs include an instruction for acquiring enemy-related information and friendly-related information at each time step in each episode, an instruction for generating a data set including a state, an action, and a reward based on the enemy-related information and friendly-related information of each time step, and an instruction for training a neural network including a value network, a critic network, and an actor network based on the data set, and the instruction for training the neural network includes an instruction for inputting a state to the value network and outputting a first prediction value, which is a scalar value, an instruction for converting the first prediction value into a first prediction probability distribution for each interval based on the first prediction value, an instruction for calculating a first target value, which is a scalar value corresponding to the first prediction value, an instruction for converting the first target value into a first target probability distribution for each interval based on the first target value, and an instruction for updating parameters of the value network based on the first prediction probability distribution and the first target probability distribution.

### BRIEF DESCRIPTION OF THE DRAWINGS

FIG. 1 is a diagram schematically illustrating a battlefield scenario for military decision making according to an embodiment of the present disclosure.

FIG. 2 is a diagram illustrating a distributional reinforcement learning device for military decision making in an offline environment according to an embodiment of the present disclosure.

FIG. 3 is a diagram illustrating information on an action of a friendly unit in an embodiment of the present disclosure.

FIG. 4 is a diagram schematically illustrating a neural network based on distributional reinforcement learning and its learning operation according to an embodiment of the present disclosure.

FIG. 5 is a flowchart illustrating a distributional reinforcement learning method for military decision making in an offline environment according to an embodiment of the present disclosure.

FIG. 6 is a flowchart illustrating a specific method for training a neural network based on distributional reinforcement learning according to an embodiment of the present disclosure.

FIG. 7 is a block diagram for illustratively describing a computing environment including a computing device suitable for use in exemplary embodiments.

### DETAILED DESCRIPTION

Hereinafter, specific embodiments of the present invention will be described with reference to the drawings. The following detailed description is provided to facilitate a comprehensive understanding of the methods, apparatuses, and/or systems described herein. However, this is only an example and the present invention is not limited thereto.

In describing embodiments of the present invention, if it is determined that a specific description of a related known function of the preset invention may unnecessarily obscure the gist of the present invention, the detailed description thereof will be omitted. The terms described below are terms defined in consideration of the functions in the present invention, and vary depending on the intention or custom of the user or operator. Therefore, the definition should be made based on the contents throughout this specification. The terminology used in the detailed description is for the purpose of describing embodiments of the present invention only and should not be construed as limiting. Unless expressly used otherwise, singular forms include plural forms. In this description, the terms “including” or “comprising” are intended to refer to certain features, numbers, steps, operations, elements, portions or combinations thereof, and should not be construed to exclude the presence or possibility of one or more other features, numbers, steps, operations, elements, portions or combinations thereof other than those described.

In addition, the terms first, second, etc. may be used to describe various components, but the components should not be limited by the terms. The terms may be used for the purpose of distinguishing one component from another component. For example, without departing from the scope of the present invention, a first component may be referred to as a second component, and similarly, a second component may also be referred to as a first component.

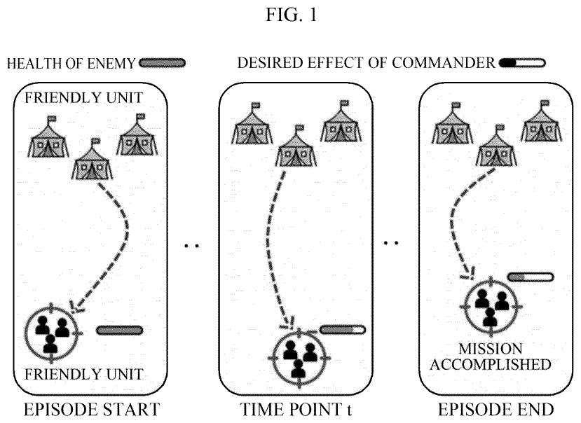

In the disclosed embodiment, a battlefield situation for military decision making considers a dynamically changing battlefield situation. FIG. 1 is a diagram schematically illustrating a battlefield scenario for military decision making according to an embodiment of the present disclosure. Referring to FIG. 1, friendly units and enemy units may be initially deployed at random locations in a battlefield environment. Each episode lasts Tₑ time, the total number of episodes is E, and each episode is independent. The enemy units may randomly move their locations within a certain range at each time point in the episode. Friendly units are represented as [symbol] ={u₁, u₂, . . . u_{U}}, and each unit has ammunition types consisting of a set of [symbol] ={w₁, w₂, . . . w_{W}}. An effect desired by the commander may be set for each episode.

Here, the goal of military decision making is to efficiently select the type and consumption amount of ammunition at the end of the episode while ensuring that a damage inflicted on the enemy matches a predefined effect desired by the commander (i.e., a damage to the enemy desired by the commander). In other words, the goal of military decision making is to efficiently select the type and consumption amount of the ammunition so that the damage inflicted on the enemy matches the effect desired by the commander.

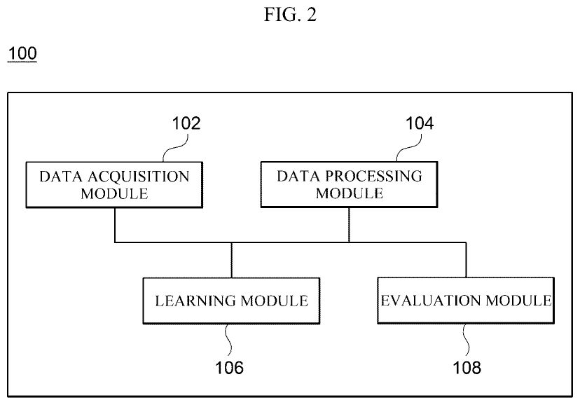

FIG. 2 is a diagram illustrating a distributional reinforcement learning device for military decision making in an offline environment according to an embodiment of the present disclosure.

Referring to FIG. 2, a distributional reinforcement learning device 100 may include a data acquisition module 102, a data processing module 104, a learning module 106, and an evaluation module 108.

The distributional reinforcement learning device 100 may be a device that performs learning in an offline environment. That is, the distributional reinforcement learning device 100 may be a device that performs distributional reinforcement learning based on pre-collected data without interacting with an environment. The distributional reinforcement learning device 100 may be configured to perform decision making to efficiently use the resources of friendly units while achieving the desired effect of a commander in a battlefield situation, based on offline reinforcement learning.

The data acquisition module 102 may acquire pre-collected data to train a neural network based on reinforcement learning. The data acquisition module 102 may acquire pre-collected data from a memory of the distributional reinforcement learning device 100 or an external database, but is not limited thereto.

In an embodiment, the data acquisition module 102 may acquire data on a simulator that implements a military operation environment. The data acquisition module 102 may acquire enemy-related information and friendly-related information for each time step in each episode.

In an embodiment, the enemy-related information may include a type of the enemy unit, a location of the enemy unit, a health of the enemy unit, and a state of the enemy unit. The friendly-related information may include a type of the friendly unit, a location of the friendly unit, a type of weapon used by the friendly unit, and an amount of ammunition used by the friendly unit.

The data processing module 104 may process the data acquired by the data acquisition module 102 into a form suitable for use in distributional reinforcement learning in the learning module 106. The data processing module 104 may generate a dataset per time step.

In an embodiment, the data processing module 104 may configure a data set to be used in distributional reinforcement learning based on the enemy-related information and the friendly-related information acquired for each time step. In this case, each data set may include information on a state, an action, and a reward. Here, the information on the reward may include a reward for each step and an n-step cumulative reward. The data processing module 104 may generate the state, the action, the reward, and the n-step cumulative reward as one data set for each time step. The data processing module 104 may transmit the data set of each time step to the learning module 106.

In an embodiment, the data processing module 104 may generate information on the state of each time step (time point t) based on the enemy-related information and friendly-related information acquired for each type step. Here, the information on the state may include a defense level according to the state of the enemy unit, a distance between the enemy unit and the friendly unit, a health of the enemy unit, a desired effect of the commander for the corresponding episode, an ammunition supply rate of each weapon of the friendly unit, and an available ammunition quantity for each weapon of the friendly unit. In an embodiment, information on a state st at time step t in the corresponding episode may be expressed as the following Equation 1.

$${s}_{t} = {[ {v}_{e} , {k}_{e} , {b}_{e} , {c}_{e} , {d}_{t} , {h}_{t} , {l}_{t} ]}^{T} \qquad Equation 1$$

vₑ: desired effect of commander)
kₑ: type of enemy unit
bₑ: defense level according to state of enemy unit
cₑ: ammunition supply rate per weapon of friendly unit
dₜ: distance between friendly unit and enemy unit at time point t
hₜ: health of enemy unit at time point t
lₜ: available ammunition quantity for each weapon per friendly unit at time point t (remaining ammunition quantity)

In addition, the data processing module 104 may generate information on the action of each time step based on the friendly unit-related information acquired for each type step.

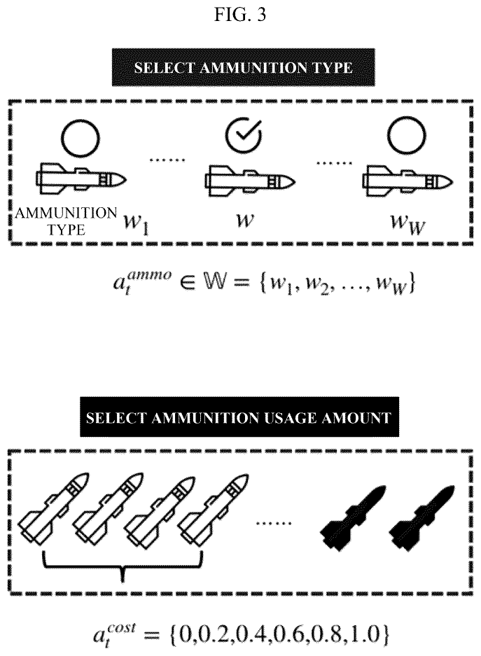

Here, the information on the action may include the type of ammunition (weapon type) selected by the friendly unit and an ammunition usage amount selected by the friendly unit, as shown in FIG. 3. In this case, the friendly unit may perform an action of selecting the type of ammunition from among the ammunition available (i.e., in stock) at the corresponding time step. The ammunition usage amount may mean an ammunition usage rate for the type of ammunition selected by the friendly unit. The ammunition usage ratio may be selected from, for example, {0, 0.2, 0.4, 0.6, 0.8, 1.0}. In an embodiment, information on an action aₜ at time step t may be expressed as the following Equation 2.

$${a}_{t} = \{ {a}_{t}^{ammo} , {a}_{t}^{cost} \} \qquad Equation 2$$

$${a}_{t}^{ammo} :$$

type of weapon selected by friendly unit at time point t

$${a}_{t}^{cost} :$$

ammunition usage rate of friendly unit at time point t

Meanwhile, the actual number of ammunitions used (ammunition usage amount) for the w weapon of a u-th friendly unit at time point t may be defined as in the following Equation 3 based on the ammunition supply rate for the corresponding weapon w.

$$α \times {c}_{e , u , w} \times {a}_{t}^{cost} \qquad Equation 3$$

α: parameter that controls maximum number of ammunitions available per unit time
c_{e,u,w}: ammunition supply rate for w weapon of u-th friendly unit

According to Equation 3, the friendly unit u may use an amount of up to α×c_{e,u,w} amount of ammunition for the corresponding weapon w at time point t. In addition, based on Equation 3, the remaining number of ammunitions (ammunition stock amount) l_{t+1,u,w} for the weapon w of the friendly unit u at time point (t+1) may be calculated using the following Equation 4.

$${l}_{t + 1 , u , w} = {l}_{t , u , w} - ( α \times {c}_{e , u , w} \times {α}_{t}^{cost} ) \qquad Equation 4$$

l_{t,u,w}: number of remaining ammunitions for weapon w of friendly unit u at time point t

That is, the number of remaining ammunitions for the weapon w of the friendly unit u at time point (t+1) may be calculated by a difference between the number of ammunitions for the weapon w used at time point t and the number of remaining ammunitions for the weapon w at time point t. In Equation 4, the total number of ammunitions of the weapon used until the end time point of the episode Tₑ cannot exceed the initial remaining quantity of the weapon, and when the number of ammunition actually determined to be used at a particular time point is greater than the remaining quantity of ammunition at that time point, it may be restricted to select up to the remaining quantity of ammunition at that time point.

In addition, the data processing module 104 may set a reward for the current time step based on information on the state and action of the current time step and information on the state of the next time step. In this case, a reward rt at time point t in the episode may be expressed as in the following Equation 5.

$${r}_{t} = {\sum }_{i = 1}^{3} {η}_{i} {R}_{t , i} \qquad Equation 5$$

ηᵢ: weight set to i-th reward function
R_{t,i}: i-th reward function at time point t

Specifically, a reward function R may include a first reward function R_{t,1} to a third reward function R_{t,3}. In an embodiment, the first reward function R_{t,1} may be a reward function that receives a reward or penalty based on a comparison between the health of the enemy unit and the health of the enemy unit desired by the commander (the desired health of the enemy unit).

In an embodiment, the first reward function R_{t,1} may be prepared so that, when the health of the enemy unit hₜ₊₁ at time (t+1) due to an attack by the friendly unit at time point t exceeds the desired health of the enemy unit, a reward is given in proportion to a difference between the health of the enemy unit hₜ at time point t and the health of the enemy unit hₜ₊₁ at time point (t+1).

In addition, the first reward function R_{t,1} may be prepared so that, when the desired health of the enemy unit exceeds the health of the enemy unit, but a difference between the health of the enemy unit and the desired health of the enemy unit exceeds a preset allowable margin, a penalty is given as much as the preset allowable margin is exceeded. Even if the desired health of the enemy unit exceeds the health of the enemy unit, when the difference between the health of the enemy unit and the desired health of the enemy unit is within the preset allowable margin, a penalty may not be given. The first reward function R_{t,1} may be expressed by Equation 6.

$${R}_{t , 1} = \{ \begin{matrix}{h}_{t} - {h}_{t + 1} , & {h}_{{v}_{e}} < {h}_{t + 1} \\ 0 , & {h}_{{v}_{e}} - ϵ < {h}_{t + 1} \leq {h}_{{v}_{e}} \\ {h}_{t + 1} - {h}_{{v}_{e}} , & {h}_{t + 1} < {h}_{{v}_{e}} - ϵ\end{matrix} \qquad Equation 6$$

hₜ: health of the enemy unit at time point t
hₜ₊₁: health of enemy unit at time point t+1
hᵥ_{ₑ}: desired health of enemy unit
ϵ: preset allowable margin

Here, the health of the enemy unit hₜ₊₁ at time point (t+1) is set by an actual number of ammunition used for the w weapon of the u-th friendly unit at time point t and a health reduction ratio of the enemy unit, which may be expressed as the following Equation 7.

$${h}_{t + 1} = {h}_{t} \times {( 1 - {p}_{t} )}^{α \times {c}_{e , u , w} \times {α}_{t}^{cost}} \qquad Equation 7$$

Here,

$${( 1 - {p}_{t} )}^{α \times {c}_{e , u , w} \times {α}_{t}^{cost}}$$

represents the health reduction ratio of the enemy unit due to the u-th friendly unit at time point t. That is, the health reduction ratio of the enemy unit may be set based on a damage amount pₜ of the enemy unit and the ammunition usage amount of the friendly unit.

The damage amount pt of the enemy unit may be determined based on the defense level of the enemy unit, a damage constant according to the type of ammunition selected by the friendly unit per type of enemy unit, and a damage function according to the distance between the friendly unit and the enemy unit. The damage amount pₜ of the enemy unit may be expressed as the following Equation 8.

$${p}_{t} = N ( p \times {b}_{e} \times δ ( {k}_{e} , {α}_{t}^{ammo} ) \times ζ ( {d}_{t} ) , σ ) \qquad Equation 8$$

N: Gaussian normal distribution function
p̅: damage constant
bₑ: defense level according to state of enemy unit

$$δ ( {k}_{e} , {α}_{t}^{ammo} ) :$$

damage constant according to type of ammunition selected by friendly unit per type of enemy unit
ζ(dₜ): damage function according to distance dₜ between friendly unit and enemy unit at time point t
σ: standard deviation for Gaussian normal distribution

A second reward function R_{t,2} may be a reward function that receives a penalty according to the ammunition usage amount of the friendly unit. The second reward function R_{t,2} may receive a penalty in proportion to the ammunition usage amount used by friendly units to attack enemy units. The second reward function R_{t,2} may be expressed as the following Equation 9.

$${R}_{t , 2} = - α \times {c}_{e , u , w} \times {α}_{t}^{cost} \qquad Equation 9$$

A third reward function R_{t,3} may be a reward function that receives a penalty when the total amount of damage inflicted by friendly units to enemy units falls below the health level desired by the commander. In other words, when the final health of the enemy units at the end of the episode falls below the health of the enemy units desired by the commander (the desired health of the enemy units), the third reward function R_{t,3} may receive a penalty. The third reward function R_{t,3} may be expressed as the following Equation 10.

$${R}_{t , 2} = \{ \begin{matrix}- 1 , & {h}_{{T}_{e}} > {h}_{{v}_{e}} \\ 0 , & otherwise\end{matrix} \qquad Equation 10$$

h_{T}_{ₑ}: final health of enemy unit at the end of episode

The data processing module 104 may calculate the n-step cumulative reward based on the reward for each time step. In the disclosed embodiment, by using the n-step cumulative reward, a long-term reward is considered compared to the reward for a single time step, and thus the future results may be better predicted.

Here, the n-step cumulative compensation may be a value obtained by accumulating the reward up to the n-th time step based on the current time step. The data processing module 104 may calculate the n-step cumulative reward for each time step based on the reward for each time step. The data processing module 104 may calculate the n-step cumulative reward Gₜ through the following Equation 11.

$${G}_{t} = {\sum }_{k = 0}^{n - 1} {γ}^{k} {r}_{t + k} \qquad Equation 11$$

γ: preset discount factor (depreciation rate)
rₜ₊ₖ: reward at time point (t+k)

The data processing module 104 may transmit a data set consisting of {state sₜ, action aₜ, reward rₜ, and n-step cumulative reward Gₜ}per time step to the learning module 106. In this way, the data processing module 104 may configure the data set by processing the data acquired by the data acquisition module 102 so that the learning module 106 may perform distributional reinforcement learning.

The learning module 106 may include a neural network based on distributional reinforcement learning. The learning module 106 may train the neural network using the data set received from the data processing module 104.

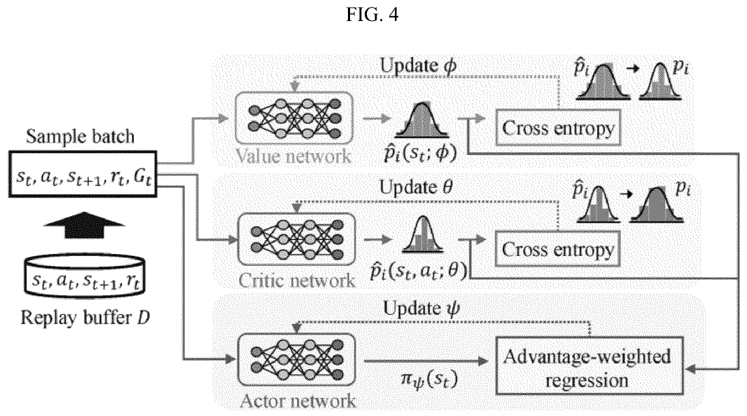

FIG. 4 is a diagram schematically illustrating a distributional reinforcement learning-based neural network and its learning operation according to an embodiment of the present disclosure. Referring to FIG. 4, the learning module 106 may include a neural network composed of a value network, a critic network, and an actor network.

Here, the value network is a network that outputs a value that may be obtained from a given state, and may output a first prediction value of a specific state by using the state as input. In addition, the critic network may output a second prediction value for an action in a specific state by using the state and the action as input. The actor network may output an action according to the current policy by using the state as input.

In this case, the prediction values output from the value network and the critic network become scalar values. In the disclosed embodiment, the prediction values output from the value network and the critic network may be expressed as categorical distributions rather than scalar values, thereby converting a regression problem into a classification problem.

Specifically, the learning module 106 may place a first additional layer and a second additional layer on an output terminal of the value network and an output terminal of the critic network, respectively. The learning module 106 may input the first prediction value output from the value network into the first additional layer to output M first logit values. Here, an estimation range for expressing the first prediction value as a distribution may be divided into M discrete intervals. In this case, a set of M discrete intervals may be expressed as

$${\{ {𝓏}_{i} \}}_{i = 1}^{M}$$

(zᵢ is an i-th interval). Also, an output of the first additional layer (i.e., a first logit value) may be expressed by Equation 12.

$${\{ {l}_{i} ( {s}_{t} ; ϕ ) \}}_{i = 1}^{M} \qquad Equation 12$$

sₜ: state at time point t
lᵢ: i-th logit value
M: number of logits
φ: parameter of first additional layer

The learning module 106 may apply a softmax function to each first logit value to calculate a first prediction probability distribution of each interval. The first prediction probability distribution \hat{p}ᵢ(sₜ;φ) of each interval may be expressed as the following Equation 13. In this way, the learning module 106 may convert the first prediction value, which is a scalar value, into the first prediction probability distribution for each interval.

$$\hat{{p}_{i}} ( {s}_{t} ; ϕ ) = \frac{exp ( {l}_{i} ( {s}_{t} ; ϕ ) )}{{\sum }_{m = 1}^{M} exp ( {l}_{m} ( {s}_{t} ; ϕ ) )} \qquad Equation 13$$

In addition, the learning module 106 may input a second prediction value output from the critic network into a second additional layer to output M second logit values. An output of the second additional layer (i.e., a second logit value) may be expressed by Equation 14.

$$\begin{matrix}{\{ {l}_{i} ( {s}_{t} , {a}_{t} ; θ ) \}}_{i = 1}^{M} & {\{ {l}_{i} ( {s}_{t} , {a}_{t} ; θ ) \}}_{i = 1}^{M}\end{matrix} \qquad Equation 14$$

aₜ: action at time point t
θ: parameter of second additional layer

The learning module 106 may apply a softmax function to each second logit value to calculate a second prediction probability distribution of each interval. The second prediction probability distribution of each interval may be expressed by Equation 15 below. In this way, the learning module 106 may convert the second prediction value, which is a scalar value, into the second prediction probability distribution for each interval.

$$\hat{{p}_{i}} ( {s}_{t} , {a}_{t} ; θ ) = \frac{exp ( {l}_{i} ( {s}_{t} , {a}_{t} ; θ ) )}{{\sum }_{m = 1}^{M} exp ( {l}_{m} ( {s}_{t} , {a}_{t} ; θ ) )} \qquad Equation 15$$

The learning module 106 may convert a first target value corresponding to the first prediction value into a first target probability distribution in order to update parameters of the value network. In addition, the learning module 106 may convert a second target value corresponding to the second prediction value into a second target probability distribution in order to update parameters of the critic network. That is, the learning module 106 may convert the first target value into the first target probability distribution of the same category as the first prediction probability distribution, and convert the second target value into the second target probability distribution of the same category as the second prediction probability distribution.

Meanwhile, the first target value at time point t (current time step) may be set based on the n-step cumulative reward and the first prediction value of the value network for an n-th time step based on the time point t. The first target value

$$\text{?}$$

$$\text{?} \text{indicates text missing or illegible when filed}$$

may be expressed as the following Equation 16. The first target value expressed by Equation 16 is a scalar value.

$$\text{?} = {\sum }_{k = 0}^{n - 1} {γ}^{k} {r}_{t + k} + {γ}^{n} {V}_{ϕ} ( \text{?} ) \qquad Equation 16$$

$$\text{?} \text{indicates text missing or illegible when filed}$$

$${\sum }_{k = 0}^{n - 1} {γ}^{k} {r}_{t + k} :$$

n-step cumulative reward
V_{φ}(sₜ₊ₙ): first prediction value of value network for n-th time step based on time point t
γ: preset discount factor (depreciation rate)

In addition, the second target value at time point t (current time step) may be set based on the reward at time point t and the first prediction value of the value network for the next time step (time point (t+1)). The second target value Q̅ₜ may be expressed as the following Equation 17. The second target value expressed by Equation 17 is a scalar value.

$${\overline{Q}}_{t} = {r}_{t} + γ {V}_{∅} ( {s}_{t + 1} ) \qquad Equation 17$$

rₜ: reward at time point t
V_{φ}(sₜ₊₁): first prediction value of value network at time point (t+1)

The learning module 106 may generate a first normal distribution by applying a Gaussian normal distribution to the first target value, and generate a second normal distribution by applying a Gaussian normal distribution to the second target value. In this case, the first normal distribution may be a normal distribution having the first target value as an average, and the second normal distribution may be a normal distribution having the second target value as an average.

The learning module 106 may define a first probability variable Y|ₛ_{ₜ} that follows the first normal distribution when a state sₜ is given, and a second probability variable Y|ₛ_{ₜ}ₐ_{ₜ} that follows the second normal distribution when the state sₜ and an action aₜ are given. The first probability variable Y|ₛ_{ₜ} and the second probability variable Y|ₛ_{ₜ}ₐ_{ₜ} may be expressed by Equations 18 and 19, respectively.

$$Y \vert \text{?} ∼ 𝒩 ( \text{?} , {σ}^{2} ) \qquad Equation 18$$

$$Y \vert \text{?} ∼ 𝒩 ( \text{?} , {σ}^{2} ) \qquad Equation 19$$

$$\text{?} \text{indicates text missing or illegible when filed}$$

Here, σ represents the variance of each normal distribution.

The learning module 106 may divide ranges of the first normal distribution and the second normal distribution into M intervals, respectively. The learning module 106 may divide an interval between a minimum value and a maximum value of the first normal distribution into M intervals, and divide an interval between a minimum value and a maximum value of the second normal distribution into M intervals. In this case, a width of the interval may be expressed as ζ=(vₘₐₓ−vₘᵢₙ)/M. Here, Emax is the maximum value of the corresponding normal distribution, and is the minimum value of the corresponding normal distribution.

The learning module 106 may calculate the first target probability distribution for each interval by integrating the first normal distribution for each interval of the first normal distribution. Here, the first target probability distribution for each interval may be expressed by Equation 20.

$${p}_{i} ( {s}_{t} ; ϕ ) = {\int }_{{z}_{i} - ϛ / 2}^{{z}_{i} + ϛ / 2} {f}_{Y \vert {s}_{t}} ( y \vert {s}_{t} ) dy = {F}_{Y \vert {s}_{t}} ( {z}_{i} + ϛ / 2 \vert {s}_{t} ) - {F}_{Y \vert {s}_{t}} ( {z}_{i} - ϛ / 2 \vert {s}_{t} ) \qquad [ Equation 20 ]$$

ƒ_{Y|s}_{ₜ}: probability density function of first normal distribution
zᵢ: center of i-th interval
F_{Y|s}_{ₜ}: cumulative distribution function of first normal distribution

The learning module 106 may calculate the second target probability distribution for each interval by integrating the second normal distribution for each interval of the second normal distribution. Here, the second target probability distribution pᵢ(sₜ,aₜ;θ) for each interval may be expressed by Equation 21.

$$\text{?} ( \text{?} ; θ ) = \text{?} ( y \vert \text{?} ) dy = \text{?} ( {z}_{i} + \text{?} / 2 \text{?} ) - \text{?} ( {z}_{i} - \text{?} / 2 \text{?} ) \qquad Equation 21$$

$$\text{?} \text{indicates text missing or illegible when filed}$$

ƒ_{Y|s}_{ₜ}ₐ_{ₜ}: probability density function of second normal distribution
F_{Y|s}_{ₜ}ₐ_{ₜ}: cumulative distribution function of second normal distribution

Through this process, the first target value and the second target value, which are scalar values, may be converted into the same category as the first prediction probability distribution and the second prediction probability distribution, respectively.

The learning module 106 may train the value network (update the parameters of the value network) based on the first prediction probability distribution for each interval and the first target probability distribution for each interval of the value network. In an embodiment, the learning module 106 may train the value network by the cross entropy (CE) loss between the first prediction probability distribution for each interval and the first target probability distribution for each interval. This may be expressed by Equation 22.

$$CE ( ϕ ) = 𝔼 [ {\sum }_{i = 1}^{M} {p}_{i} ( {s}_{t} ; ϕ ) log {\hat{p}}_{i} ( {s}_{t} ; ϕ ) ] \qquad Equation 22$$

M: number of intervals
\hat{p}ᵢ(sₜ;φ): first prediction probability distribution of i-th interval
pᵢ(sₜ;φ): first target probability distribution of i-th interval

The learning module 106 may train the critic network based on the second prediction probability distribution for each interval and the second target probability distribution for each interval of the critic network. In an embodiment, the learning module 106 may train the critic network by the cross entropy loss between the second prediction probability distribution for each interval and the second target probability distribution for each interval. This may be expressed by Equation 23.

$$CE ( θ ) = 𝔼 [ {\sum }_{i = 1}^{M} {p}_{i} ( {s}_{t} , {a}_{t} ; θ ) log {\hat{p}}_{i} ( {s}_{t} , {a}_{t} ; θ ) ] \qquad Equation 23$$

\hat{p}ᵢ(sₜ,aₜ;θ): second prediction probability distribution of i-th interval
pᵢ(sₜ,aₜ;θ): second target probability distribution of i-th interval

In addition, the learning module 106 may train the actor network so that a difference between an action π(sₜ) predicted by the actor network and the action aₜ in the data set is minimized. In this case, the learning module 106 may use an advantage function to weight to follow an action having a high value. The advantage function may be set as a difference between a prediction value of the critic network and a prediction value of the value network. That is, the actor network may be trained by a loss function expressed as the following Equation 24.

$${L}_{π} ( ψ ) = \text{?} [ exp ( β ( {\hat{Q}}_{θ} ( {s}_{t} , {a}_{t} ) - {\hat{V}}_{ϕ} ( {s}_{t} ) ) {‖ {a}_{t} - {π}_{ψ} ( {s}_{t} ) ‖}^{2} ] \qquad Equation 24$$

$$\text{?} \text{indicates text missing or illegible when filed}$$

\hat{Q}_{θ}(sₜ,aₜ)−\hat{V}_{φ}(sₜ): advantageous function
β: hyperparameter that controls sensitivity to advantage function

Here, the prediction value \hat{V}_{φ}(sₜ) of the value network may use a mode value of the first prediction probability distribution \hat{p}ᵢ(sₜ;φ) of each interval. Here, the mode value may mean a value with the highest prediction probability in each interval. The prediction value \hat{V}_{φ}(sₜ) of the value network used in the advantage function may be expressed as the following Equation 25.

$${\hat{V}}_{ϕ} ( {s}_{t} ) = \text{?} \qquad Equation 25$$

$$\text{?} \text{indicates text missing or illegible when filed}$$

In addition, the prediction value \hat{Q}_{θ}(sₜ,aₜ) of the critic network may use a mode value of the second prediction probability distribution \hat{p}ᵢ(sₜ,aₜ;θ) of each interval. Here, the mode value may mean the value with the highest prediction probability in each interval. The prediction value \hat{Q}_{θ}(sₜ,aₜ) of the critic network used in the advantage function may be expressed as the following Equation 26.

$${\hat{Q}}_{θ} ( {s}_{t} , {a}_{t} ) = \text{?} \qquad Equation 26$$

$$\text{?} \text{indicates text missing or illegible when filed}$$

The evaluation module 108 may evaluate the performance of the neural network based on distributional reinforcement learning trained by the learning module 106 through preset evaluation metrics. Here, the evaluation metrics may include an episode achievement rate (a first evaluation metric), a desired health error rate (a second evaluation metric), an ammunition usage cost (a third evaluation metric), and an ammunition efficiency (a fourth evaluation metric).

The evaluation module 108 may calculate the achievement rate for each episode. The evaluation module 108 may determine that the episode is achieved if a difference between a final health of the enemy unit at the end of the episode and the desired health of the enemy unit is within a preset allowable margin, and may determine that the episode is not achieved if the difference is outside; the allowable margin. The evaluation module 108 may calculate the episode achievement rate F by the following Equation 27.

$$F = \frac{1}{E} {\sum }_{e = 1}^{E} f ( e ) \times 100 \qquad Equation 27$$

E: total number of episodes
f(e): achievement function for e-th episode

Here, the achievement function f(e) for the e-th episode may be a function for determining whether the episode is achieved according to whether the difference between the final health of the enemy unit at the end of the episode and the desired health of the enemy unit is within the preset allowable margin. For example, if the difference is within the preset allowable margin, f(e) may be 1, and if the difference is outside the preset allowable margin, f(e) may be 0.

The evaluation module 108 may calculate a desired health error rate based on a difference between the desired health of the enemy unit due to the desired effect of the commander per each episode and the final health of the enemy unit. The evaluation module 108 may calculate the desired health error rate P through the following Equation 28.

$$P = \frac{1}{E} {\sum }_{e = 1}^{E} \frac{\vert {h}_{{T}_{e}} - {h}_{{v}_{e}} \vert}{{h}_{{v}_{e}}} \times 100 \qquad Equation 28$$

The evaluation module 108 may calculate the cost according to the amount of ammunition used by the friendly unit (i.e., the ammunition usage cost) per episode. The evaluation module 108 may calculate the ammunition usage cost C through the following Equation 29.

$$C = \frac{1}{E} {\sum }_{e = 1}^{E} {\sum }_{t = 1}^{T} ( α \times {c}_{e , u , w} \times {a}_{t}^{cost} ) \qquad Equation 29$$

The evaluation module 108 may calculate ammunition efficiency, which indicates how efficiently the friendly unit consumed ammunition per each episode. The evaluation module 108 may calculate the ammunition efficiency based on the achievement function f(n) of each episode and the ammunition usage amount upon episode achievement. The evaluation module 108 may calculate the ammunition efficiency H through the following Equation 30.

$$H = \frac{{\sum }_{e = 1}^{E} f ( e )}{{\sum }_{e = 1}^{E} {\sum }_{t = 1}^{T} f ( e ) \cdot ( α \times {c}_{e , u , w} \times {a}_{t}^{cost} )} \qquad Equation 30$$

The evaluation module 108 may assign an evaluation score for each of a first to fourth evaluation metrics. The evaluation module 108 may assign a higher evaluation score as the first evaluation metric (the achievement rate of the episode) is higher. The evaluation module 108 may assign a higher evaluation score as the second evaluation metric (the desired health error rate) is lower. The evaluation module 108 may assign a higher evaluation score as the third evaluation metric (the ammunition usage cost) is lower. The evaluation module 108 may assign a higher evaluation score as the fourth evaluation metric (the ammunition efficiency) is higher. The evaluation module 108 may evaluate the performance of the neural network by adding up the evaluation scores each assigned for each of the first to fourth evaluation metrics.

According to the disclosed embodiments, a decision making policy for efficient firepower (e.g., a policy for selecting ammunition types and ammunition usage amount) can be determined according to the desired effect of a commander in a dynamic military environment. In addition, learning can be performed by utilizing a pre-collected and processed data set without additional interaction with the real environment through offline reinforcement learning. In addition, a technical effect that can simultaneously improve the accuracy, stability, and resource efficiency of decision making is provided by integrating distributional reinforcement learning and an n-step cumulative reward-based learning structure in an offline environment.

In this specification, the term “module” may mean a functional and structural combination of hardware for performing the technical idea of the present invention and software for operating the hardware. For example, the “module” may mean a logical unit of a given code and hardware resources for performing the given code, and does not necessarily mean physically connected code or a type of hardware.

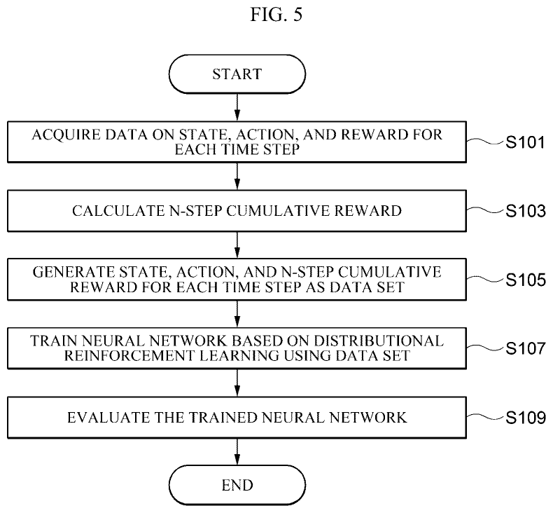

FIG. 5 is a flowchart describing a distributional reinforcement learning method for military decision making in an offline environment according to an embodiment of the present disclosure. Although the method is described as being divided into a plurality of steps in the illustrated flowchart, at least some of the steps may be performed in a different order, performed together by being combined with other steps, omitted, performed by being divided into sub-steps and, or performed by adding one or more steps (not shown).

Referring to FIG. 5, the distributional reinforcement learning device 100 may acquire data on a state, an action of an object, and a reward for each time step in each episode for a preset environment (S 101). The distributional reinforcement learning device 100 may acquire enemy-related information and friendly-related information at each time step in each episode.

Next, the distributional reinforcement learning device 100 may calculate an n-step cumulative reward for each time step based on the reward for each time step (S 103), and may generate the state, action, reward, and n-step cumulative reward for each time step as one data set (S 105).

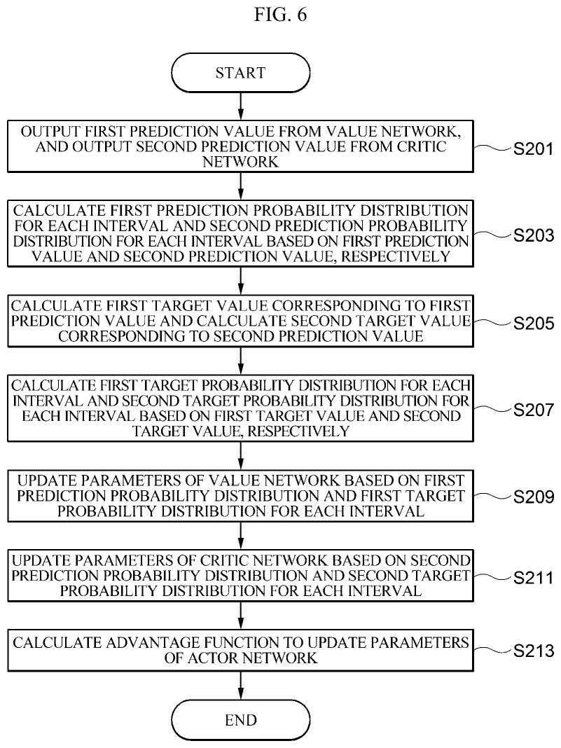

Next, the distributional reinforcement learning device 100 may train a distributional reinforcement learning-based neural network using the data set consisting of the state, action, and n-step cumulative reward for each time step (S 107). This will be described below with reference to FIG. 6.

Next, the distributional reinforcement learning device 100 may evaluate the trained neural network using a preset evaluation metric (S 109). Here, the evaluation metric may include an episode achievement rate, a desired health error rate, ammunition usage cost, and ammunition efficiency.

FIG. 6 is a flowchart showing a specific method for training the distributional reinforcement learning-based neural network according to an embodiment of the present disclosure. Although the method is described as being divided into a plurality of steps in the illustrated flowchart, at least some of the steps may be performed in a different order, performed together by being combined with other steps, omitted, performed by being divided into sub-steps and, or performed by adding one or more steps (not shown).

Referring to FIG. 6, the distributional reinforcement learning device 100 may input a state from a data set into a value network to output a first prediction value therefrom, and input the state and an action from the data set into a critic network to output a second prediction value therefrom (S 201).

Next, the distributional reinforcement learning device 100 may calculate a first prediction probability distribution for each interval and a second prediction probability distribution for each interval based on the first prediction value and the second prediction value, which are scalar values, respectively (S 203).

Next, the distributional reinforcement learning device 100 may calculate a first target value corresponding to the first prediction value and a second target value corresponding to the second prediction value (S 205).

Next, the distributional reinforcement learning device 100 may calculate a first target probability distribution for each interval and a second target probability distribution for each interval based on the first target value and the second target value, which are scalar values, respectively (S 207).

Next, the distributional reinforcement learning device 100 may update parameters of the value network based on the first prediction probability distribution and the first target probability distribution for each interval (S 209).

Next, the distributional reinforcement learning device 100 may update parameters of the critic network based on the second prediction probability distribution and the second target probability distribution for each interval (S 211).

Next, the distributional reinforcement learning device 100 may calculate an advantage function using a mode value of the first prediction probability distribution for each interval and a mode value of the second prediction probability distribution for each interval, and update parameters of an actor network based on the calculated advantage function (S 213).

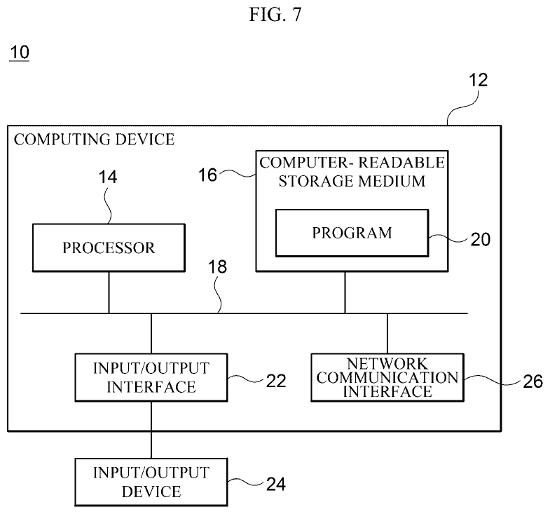

FIG. 7 is a block diagram for illustrating a computing environment 10 including a computing device suitable for use in exemplary embodiments. In the illustrated embodiment, respective components may have different functions and capabilities other than those described below, and include additional components in addition to those described below.

The illustrated computing environment 10 includes a computing device 12. In an embodiment, the computing device 12 may be the distributional reinforcement learning device 100.

The computing device 12 includes at least one processor 14, a computer-readable storage medium 16, and a communication bus 18. The processor 14 may cause the computing device 12 to operate according to the exemplary embodiment described above. For example, the processor 14 may execute one or more programs stored on the computer-readable storage medium 16. The one or more programs may include one or more computer-executable instructions, which, when executed by the processor 14, may be configured so that the computing device 12 performs operations according to the exemplary embodiment.

The computer-readable storage medium 16 is configured to store the computer-executable instruction or program code, program data, and/or other suitable forms of information. A program 20 stored in the computer-readable storage medium 16 includes a set of instructions executable by the processor 14. In an embodiment, the computer-readable storage medium 16 may be a memory (volatile memory such as a random access memory, non-volatile memory, or any suitable combination thereof), one or more magnetic disk storage devices, optical disk storage devices, flash memory devices, other types of storage media that are accessible by the computing device 12 and capable of storing desired information, or any suitable combination thereof.

The communication bus 18 interconnects various other components of the computing device 12, including the processor 14 and the computer-readable storage medium 16.

The computing device 12 may also include one or more input/output interfaces 22 that provide an interface for one or more input/output devices 24, and one or more network communication interfaces 26. The input/output interface 22 and the network communication interface 26 are connected to the communication bus 18. The input/output device 24 may be connected to other components of the computing device 12 through the input/output interface 22. The exemplary input/output device 24 may include a pointing device (such as a mouse or trackpad), a keyboard, a touch input device (such as a touch pad or touch screen), a speech or sound input device, input devices such as various types of sensor devices and/or photographing devices, and/or output devices such as a display device, a printer, a speaker, and/or a network card. The exemplary input/output device 24 may be included inside the computing device 12 as a component configuring the computing device 12, or may be connected to the computing device 12 as a separate device distinct from the computing device 12.

According to the disclosed embodiments, a decision making policy for efficient firepower (e.g., a policy for selecting ammunition types and ammunition usage amount) can be determined according to the desired effect of a commander in a dynamic military environment. In addition, learning can be performed by utilizing a pre-collected and processed data set without additional interaction with the real environment through offline reinforcement learning. In addition, a technical effect that can simultaneously improve the accuracy, stability, and resource efficiency of decision making is provided by integrating distributional reinforcement learning and an n-step cumulative reward-based learning structure in an offline environment.

Although representative embodiments of the present invention have been described in detail above, those skilled in the art will understand that various modifications may be made to the above-described embodiments without departing from the scope of the present invention. Therefore, the scope of the present invention should not be limited to the described embodiments, but should be defined not only by the patent claims described below but also by those equivalent to the patent claims.

What is claimed is:

1. A learning method performed on a computing device that includes one or more processors and a memory storing one or more programs executed by the one or more processors, the learning method comprising:
acquiring enemy-related information and friendly-related information at each time step in each episode;
generating a data set including a state, an action, and a reward based on the enemy-related information and friendly-related information of each time step; and
training a neural network including a value network, a critic network, and an actor network based on the data set,
wherein the training of the neural network includes:
inputting a state to the value network and outputting a first prediction value, which is a scalar value;
converting the first prediction value into a first prediction probability distribution for each interval based on the first prediction value;
calculating a first target value, which corresponds to the first prediction value and is a scalar value;
converting the first target value into a first target probability distribution for each interval based on the first target value; and
updating parameters of the value network based on the first prediction probability distribution and the first target probability distribution.

2. The learning method of claim 1, wherein the converting into the first prediction probability distribution includes:
inputting the first prediction value output from the value network into a first additional layer connected to an output terminal of the value network to output first logit values of a plurality of intervals; and
calculating the first prediction probability distribution of each interval by applying a softmax function to each of the first logit values.

3. The learning method of claim 1, wherein the generating of the data set includes calculating an n-step cumulative reward for each time step based on the reward for each time step, and
in the calculating of the first target value, the first target value is calculated based on an n-step cumulative reward for the current time step and the first prediction value of the value network for an n-th time step based on the current time step.

4. The learning method of claim 3, wherein the converting into the first target probability distribution includes:
generating a first normal distribution, which is a normal distribution having the first target value as an average;
dividing an interval between a minimum value and a maximum value of the first normal distribution into a plurality of intervals; and
calculating a first target probability distribution for each interval by integrating the first normal distribution for each interval of the first normal distribution.

5. The learning method of claim 1, wherein the training of the neural network further includes:
inputting a state and an action to the critic network and outputting a second prediction value, which is a scalar value;
converting the second prediction value into a second prediction probability distribution for each interval based on the second prediction value;
calculating a second target value, which is a scalar value and corresponds to the second prediction value;
converting the second target value into a second target probability distribution for each interval based on the second target value; and
updating parameters of the critic network based on the second prediction probability distribution and the second target probability distribution.

6. The learning method of claim 5, wherein the converting into the second prediction probability distribution includes:
inputting the second prediction value output from the critic network into a second additional layer connected to an output terminal of the critic network to output second logit values of a plurality of intervals; and
calculating the second prediction probability distribution of each interval by applying a softmax function to each of the second logit values.

7. The learning method of claim 5, wherein, in the calculating of the second target value, the second target value is calculated based on a reward for the current time step and the first prediction value of the value network for the next time step.

8. The learning method of claim 7, wherein the converting into the second target probability distribution includes:
generating a second normal distribution which is a normal distribution having the second target value as an average;
dividing an interval between a minimum value and a maximum value of the second normal distribution into a plurality of intervals; and
calculating a second target probability distribution for each interval by integrating the second normal distribution for each interval of the second normal distribution.

9. The learning method of claim 5, further comprising:
inputting a state into the actor network and outputting a predicted action;
calculating an advantage function based on a difference between a mode value of the first prediction probability distribution for each interval and a mode value of the second prediction probability distribution for each interval; and
updating parameters of the actor network based on a difference between the predicted action and the action in the data set and the advantage function.

10. The learning method of claim 1, wherein information on the state includes one or more of a defense level according to a state of an enemy unit, a distance between the enemy unit and a friendly unit, a health of the enemy unit, a desired effect of a commander for the corresponding episode, an ammunition supply rate of each weapon of the friendly unit, and an available ammunition quantity for each weapon of the friendly unit, and
information on the action includes one or more of a type of friendly unit performing the action, an ammunition type selected by the friendly unit, and an ammunition usage amount selected by the friendly unit.

11. The learning method of claim 10, wherein, in the generating of the data set, a reward for the current time step is set based on information on the state and action of the current time step and information on the state of the next time step, and the reward is set based on one or more preset reward functions,
the reward functions include a first reward function, and
the first reward function is prepared to receive a reward or a penalty based on a comparison between the health of the enemy unit and the desired health of the enemy unit.

12. The learning method of claim 11, wherein the first reward function is prepared so that, when the health of the enemy unit of the next time step exceeds the desired health of the enemy unit, a reward is given in proportion to a difference between the health of the enemy unit and the desired health of the enemy unit, and is prepared so that, if the desired health of the enemy unit exceeds the health of the enemy unit in the next time step, but the difference between the health of the enemy unit and the desired health of the enemy unit exceeds a preset allowable margin, a penalty is given as much as the allowable margin is exceeded.

13. The learning method of claim 12, wherein the generating of the data set includes calculating the health of the enemy unit of the next time step based on the health of the enemy unit of the current time step, the ammunition usage amount of an ammunition type selected by the friendly unit of the current time step, and a health reduction ratio of the enemy unit caused by the friendly unit.

14. The learning method of claim 11, wherein the reward function further includes a second reward function, and
the second reward function is prepared so that a penalty is given in proportional to the ammunition usage amount of the friendly unit of the current time step.

15. The learning method of claim 14, wherein the reward function further includes a third reward function, and
the third reward function is prepared so that when the final health of the enemy unit at the end of the episode falls below the desired health of the enemy unit, a penalty is given thereto.

16. A computing device comprising:
one or more processors;
a memory; and
one or more programs,
wherein the one or more programs are stored in the memory and configured to be executed by the one or more processors, and
the one or more programs include:
an instruction for acquiring enemy-related information and friendly-related information at each time step in each episode;
an instruction for generating a data set including a state, an action, and a reward based on the enemy-related information and friendly-related information of each time step; and
an instruction for training a neural network including a value network, a critic network, and an actor network based on the data set, and
the instruction for training the neural network includes:
an instruction for inputting a state to the value network and outputting a first prediction value, which is a scalar value;
an instruction for converting the first prediction value into a first prediction probability distribution for each interval based on the first prediction value;
an instruction for calculating a first target value, which is a scalar value corresponding to the first prediction value;
an instruction for converting the first target value into a first target probability distribution for each interval based on the first target value; and
an instruction for updating parameters of the value network based on the first prediction probability distribution and the first target probability distribution.

17. A computer program stored in a non-transitory computer readable storage medium, wherein the computer program includes one or more instructions, and the instructions, when executed by a computing device including one or more processors, cause the computing device to perform:
acquiring enemy-related information and friendly-related information at each time step in each episode;
generating a data set including a state, an action, and a reward based on the enemy-related information and friendly-related information of each time step; and
training a neural network including a value network, a critic network, and an actor network based on the data set, and
the training of the neural network includes:
inputting a state to the value network and outputting a first prediction value, which is a scalar value;
converting the first prediction value into a first prediction probability distribution for each interval based on the first prediction value;
calculating a first target value, which corresponds to the first prediction value and is a scalar value;
converting the first target value into a first target probability distribution for each interval based on the first target value; and
updating parameters of the value network based on the first prediction probability distribution and the first target probability distribution.
